(19) United States
(12) Patent Application Publication
(10) Pub. No.: US 2005/0090174 A1
(43) Pub. Date: Apr. 28, 2005

(54) Non-woven fabric based layered product and manufacturing method therefor

(75) Inventor: Maurizio Peruzzo, Bassano del grappa (IT)

Correspondence Address: MODIANO & ASSOCIATI, Via Meravigli, 16, MILANO, 20123, IT

(73) Assignee: O.R.V. - OVATTIFICIO RESINATURA VALPADANA S.P.A.

(21) Appl. No.: 10/945,986

(22) Filed: Sep. 22, 2004

(30) Foreign Application Priority Data
Oct. 24, 2003 (IT) PD2003A000260

(51) Int. Cl. B32B 1/00

(52) U.S. Cl. 442/374

(57) ABSTRACT

A reinforced layered product based on non-woven fabric, comprising: at least one web of hydroentangled non-woven fabric; at least one layer of a mixture based on foamable resin that is resistant to abrasion, soft and light-fast, and covers at least one of the two sides of the at least one web of non-woven fabric.

The present invention relates to a layered product based on non-woven fabric.

The product is used particularly but not exclusively for exposed trims in the field of motor vehicles or of vehicles in general, as an internal lining for the cabin roof.

Applications in the field of furniture and clothing, for example, are also foreseeable.

The invention also relates to the method for manufacturing the layered product.

### BACKGROUND OF THE INVENTION

It is known that the internal lining of the roof of the cabin of cars or vehicles in general is composed of a soft padding designed to act as a barrier, generally made of at least one web of non-woven fabric, and of an exposed fabric lining, such as a jersey or a Malivlies fabric, for outward appearance.

This structure arises because it is currently impossible to provide a non-woven fabric that can be used, on its own, for exposed trims.

The non-woven fabric that is used, in view of its nature (polyester and/or polyamide fibers) and of its technical and structural characteristics, is in fact currently unable to pass the tests normally used by car manufacturers for resistance to abrasion, safety and light-fastness (the product degrades over time due to solar radiation).

### SUMMARY OF THE INVENTION

The aim of the present invention is to provide a layered product based on non-woven fabric that can be used as is for exposed trims, accordingly without the need to combine it, outside of its production cycle, with covering elements.

Within this aim, an object of the present invention is to provide a layered product based on non-woven fabric that allows a manufacturing simplification of exposed trims and a cost reduction.

Another object is to provide a layered product based on non-woven fabric that allows higher flexibility of the production process to obtain a finished product having the most disparate appearances.

Another object is to provide a layered product based on non-woven fabric that can be manufactured with a method that is advantageous in terms of hourly productivity.

Another object is to provide a layered product based on non-woven fabric that can be manufactured without particular technological complications with respect to known products.

Another object is to provide a layered product based on non-woven fabric whose cost for raw materials is not higher than that of current products.

Another object is to provide a layered product based on non-woven fabric that can be manufactured by using current facilities.

This aim and these and other objects that will become better apparent hereinafter are achieved by a layered product based on non-woven fabric, characterized in that it comprises:
at least one web of hydroentangled non-woven fabric;
at least one layer of a mixture based on foamable resin that is resistant to abrasion, soft and light-fast, and covers at least one of the two sides of said at least one web of non-woven fabric.

Advantageously, the method for manufacturing said layered product based on non-woven fabric consists in applying to the surface, on at least one side of an intermediate component composed of at least one web of non-woven fabric, a mixture based on a resin selected among polyurethane- and/or acrylic-based foamable resins that are resistant to abrasion, soft and light-fast.

### BRIEF DESCRIPTION OF THE DRAWINGS

Further characteristics and advantages of the present invention will become better apparent from the following detailed description of a preferred but not exclusive embodiment thereof, and of its production method, illustrated by way of non-limiting example in the accompanying drawings, wherein:

FIG. 1 is a view of a first embodiment of an apparatus for producing the layered product according to the invention;

FIG. 2 is a view of a second embodiment of an apparatus for producing the layered product according to the invention;

FIG. 3 is a view of a third embodiment of an apparatus for producing the layered product according to the invention.

### DESCRIPTION OF THE PREFERRED EMBODIMENTS

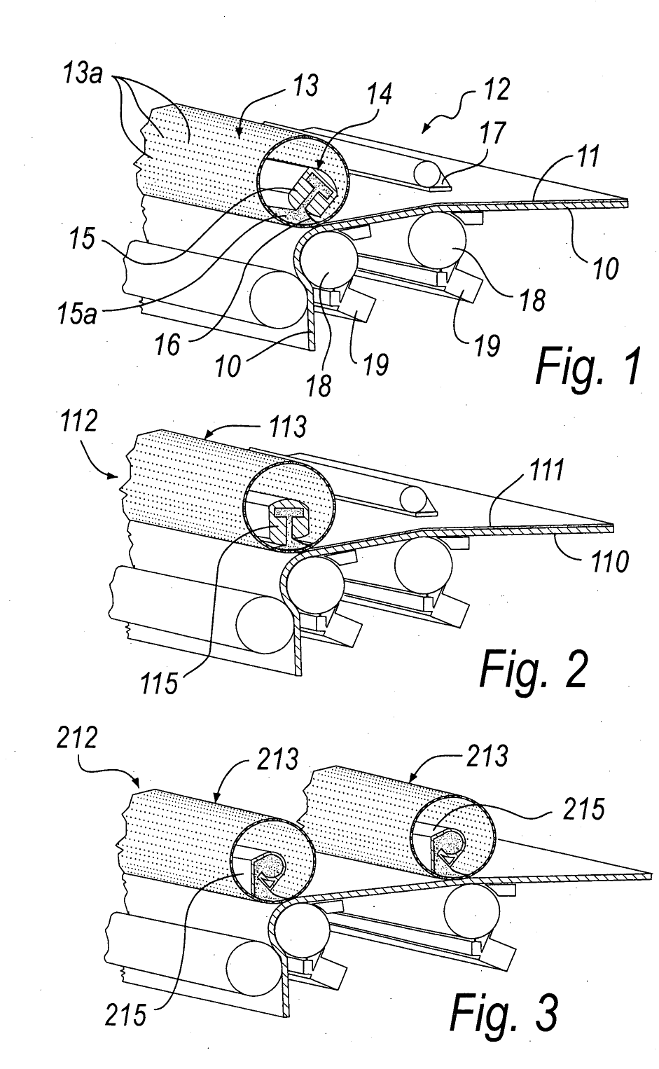

With reference to FIG. 1, a layered product based on non-woven fabric according to the invention comprises at least one web 10 of non-woven fabric and at least one layer 11 of a mixture based on foamable resin that is resistant to abrasion, soft and light-fast, and covers at least one of the two sides of the at least one web 10 of non-woven fabric.

Preference is given to a plurality of webs of hydroentangled non-woven fabric (hydroentanglement is designed to make the basic substrate more uniform and therefore more suitable for the end result) and a mixture based on resin, selected in a group comprising polyurethane- and/or acrylic-based resins.

In particular, the composition of the non-woven fabric can be for example selected advantageously among the following (% by weight):
100% polyester
70% polyester, 30% polyamide
50% polyester, 50% polyamide

As regards the resin mixture, it can be conveniently for example (% by weight):
cross-linking acrylic resin 57.4%
cross-linking agent 0.7%
expanding agent 7.0%
stabilizing fillers 10.5%
color 7.0%
thickening agents 3.4%
deionized water 14.0%

Also by way of example, the finished product can be constituted by:
120-140 g/m² of non-woven fabric
30-40 g/m² of resin-based mixture
final thickness: 1-1.2 mm
final grammage: 150-180 g/m²

The method for producing such layered product based on non-woven fabric consists of a preliminary step for producing the hydroentangled non-woven fabric by using oven temperatures of approximately 60-80° C., lower than the background art, and by keeping the stretching during fiber carding at low levels in order to achieve very high longitudinal elongations, and in then applying the resin-based mixture on the surface of at least one side.

The required elongations are:

at 20 N in a longitudinal direction 2.2-3.5%

at 20 N, in a transverse direction 6.5-11%

at 50 N, in a longitudinal direction 9.0-15%

at 50 N, in a transverse direction 20-27%

at 100 N, in a longitudinal direction 20-27%

at 100 N, in a transverse direction 32-38%

The method of application of the resin-based mixture is such that it does not stress the material and at the same time is capable of distributing a very low quantity of resin absolutely uniformly, for example 30 to 40 g/m², as already mentioned, it avoids losing the particular characteristics of the non-woven fabric (strengths, elongations, et cetera), and finally allows said resin to remain on the surface as much as possible.

The preferred method is the application of foamed resin by means of a rotating cylinder, as described hereinafter.

FIG. 1 is a diagram of an apparatus, generally designated by the reference numeral 12, for depositing the layer of foamed resin 11 on the web 10.

The apparatus 12 comprises a rotating cylinder 13, for example such as the one manufactured by the Stork company, which is combined with a foaming unit, designated by the reference numeral 14, of which only a component described hereinafter is shown.

The rotating cylinder 13 is hollow, with through holes 13a formed uniformly on the wall, and is provided internally with a device 15 for distributing the foam (designated by the reference numeral 15a) on the wall of the cylinder 13.

The device 15, of a per se known type, is termed “squeegee” and is part of the foaming unit 14.

The foaming unit 14 has a very important role, since the density of the foam directly influences the quantity of resin deposited on the material.

Once the foam of the chosen density has been obtained, it passes within the squeegee 15, which is provided with a spreading blade 16; the blade 16 can have different lengths and can therefore give flexibility to the dosage system. It is also possible to adjust the inclination angle and the pressure applied by the blade 16 to the cylinder 13.

In practice, for each foam density, by acting on the adjustments of the squeegee it is possible to distribute uniformly different quantities of resin, ranging from 5 to 120 g/m².

The apparatus 12 further has an additional blade 17 for adjusting the thickness of the layer of resin 11, which is external with respect to the rotating cylinder 13 and arranged downstream thereof.

The additional adjustment blade 17 provides adjustment of the thickness once the resin has been deposited by the cylinder 13 on the web 10.

The system for moving the web 10 is provided by conveyor rollers 18 that are arranged opposite the rotating cylinder 13.

In practice, the web 10 passes through the sort of calender formed by the conveyor rollers 18 and by the rotating cylinder 13.

Respective washing devices 19, of a per se known type, for the web 10 are associated with the rollers 18.

FIG. 2 illustrates a diagram of a second embodiment of the apparatus for depositing said layer of foamed resin on at least one hydroentangled web; said apparatus is now designated by the reference numeral 112.

In this embodiment, the squeegee device 115 arranged inside the cylinder 113 is inclined with respect to the first embodiment of FIG. 1, so as to indicate the possibility to provide embodiments of the apparatus that have mutually different inclinations of the exit of the resin 111, in order to optimize the step for distributing said resin on the at least one hydroentangled web 110.

FIG. 3 illustrates a diagram of a third embodiment of the apparatus for depositing said layer of foamed resin on at least one hydroentangled web; said apparatus is now designated by the reference numeral 212.

In this embodiment there are two rotating cylinders 213 in series containing a squeegee 215, so as to obtain a different flexibility on the control of the thickness of the layer of resin and on the number of layers.

In practice it has been found that the present invention has achieved the intended aim and objects.

The layered product based on non-woven fabric described above can in fact be used as is for exposed trims, without therefore having to be combined, outside of its production cycle, with covering fabrics, saving their corresponding costs.

The layered product allows a manufacturing simplification of exposed trims and a cost reduction, and also allows higher flexibility of the manufacturing process in order to obtain a finished product that has the most disparate appearances, for example by means of successive printing operations performed on the exposed surface.

As the skilled in the art would understand, all the technical details may further be replaced with other technically equivalent elements.

The materials, so long as they are compatible with the contingent use, as well as the dimensions, may be any according to requirements, without thereby abandoning the scope of the protection of the appended claims.

The disclosures in Italian Patent Application No. PD2003A000260 from which this application claims priority are incorporated herein by reference.

1. A layered product based on non-woven fabric, comprising:
at least one web of hydroentangled non-woven fabric having two sides;
at least one layer of a mixture based on a foamable resin that is resistant to abrasion, soft and light-fast, said at least one layer covering at least one of the two sides of said at least one web of non-woven fabric.

2. The layered product based on non-woven fabric of claim 1, wherein said at least one web of non-woven fabric is substantially 100% polyester.

3. The layered product based on non-woven fabric of claim 1, wherein said at least one web of non-woven fabric is substantially 70% polyester and 30% polyamide.

4. The layered product based on non-woven fabric of claim 1, wherein said at least one web of non-woven fabric is substantially 50% polyester and 50% polyamide.

5. The layered product based on non-woven fabric of claim 1, wherein said mixture resin is selected in a group comprising polyurethane- and acrylic-based resins, polyurethane resins, and acrylic-based resins.

6. The layered product based on non-woven fabric of claim 1, wherein said resin-based mixture is composed of:
cross-linking acrylic resin 57.4%;
cross-linking agent 0.7%;
expanding agent 7.0%;
stabilizing fillers 10.5%;
color 7.0%;
thickening agents 3.4%; and
deionized water 14.0%, by weight.

7. The layered product based on non-woven fabric of claim 1, constituted by:
120-140 g/m² of non-woven fabric; and
30-40 g/m² of resin.

8. A method for producing a layered product based on non-woven fabric as set forth in claim 1, consisting in: applying at a surface, on at least one side of an intermediate component composed of at least one web of non-woven fabric, a mixture based on resins selected in a group comprising foamable, abrasion-resistant, soft and light-fast polyurethane- and acrylic-based resins, polyurethane resins, and acrylic-based resins.

9. The method of claim 8, consisting in applying foamed resin by way of at least one rotating cylinder, which is hollow and has through holes on a peripheral wall thereof, with, provided internally, a device for distributing the foamed resin of a “squeegee” type.
